(19) United States
(12) Patent Application Publication
(10) Pub. No.: US 2013/0283313 A1
(43) Pub. Date: Oct. 24, 2013

(54) INFORMATION PROCESSING DEVICE AND SYSTEM

(71) Applicant: PANASONIC CORPORATION, Osaka (JP)

(72) Inventors: Yuichiro MIYAMOTO, Osaka (JP); Shinichi YAMAMOTO, Osaka (JP)

(73) Assignee: PANASONIC CORPORATION, Osaka (JP)

(21) Appl. No.: 13/751,314

(22) Filed: Jan. 28, 2013

(30) Foreign Application Priority Data
Apr. 24, 2012 (JP) 2012-098443
Nov. 13, 2012 (JP) 2012-249025

(51) Int. Cl. H04N 21/81

(52) U.S. Cl. CPC H04N 21/81
USPC 725/37; 725/93

(57) ABSTRACT

An information processing device in an embodiment includes a network interface configured to perform communication with a first server that stores an electronic document, a second server that stores a recorded program, and a third server that stores keyword information associated to the recorded program; a user interface configured to accept an operation made by a user; and a controller configured to cause a display screen to display the electronic document acquired from the first server. The controller transmits, in response to a selection made by the user, information relevant to selected contents in the electronic document to the third server, acquires, from the third server, information specifying at least one recorded program associated to keyword information matching to, or similar to, the transmitted information, and reproduces the recorded program stored on the second server.

### BACKGROUND

1. Technical Field

The present disclosure relates to an information processing device for displaying information relevant to an electronic document such as a newspaper article, and a system including such an information processing device.

2. Description of the Related Art

A technology for displaying newspaper image data, which is received via a communication line and represents actual pages of newspaper, on a display screen of a personal computer (PC) or the like is described in, for example, Japanese Laid-Open Patent Publication No. 2007-323369.

There is also a technology for allowing newspaper provided in paper to be viewed as an electronic version of the newspaper by a terminal such as a smartphone or the like (hereinafter, referred to as an “information processing device”). A user can have an image of a page of the newspaper displayed on an information processing device or browse latest news (hereinafter, referred to also as “breaking news”) by installing a newspaper application onto the information processing device. By use of such an information processing device, the user can read newspaper or breaking news conveniently outside his/her home, for example, on his/her way to work or school.

### SUMMARY

According to the conventional technology, information on a recorded program or the like relevant to an article or a term in an electronic document such as newspaper, a book, a magazine, an academic journal or the like cannot be provided easily and in a timely manner.

One non-limiting, and exemplary embodiment of the present disclosure provides a technology by which information on a recorded program or the like relevant to an article or a term in an electronic document such as newspaper contents or the like is provided easily and in a timely manner.

In one general aspect, an information processing device disclosed herein includes a network interface configured to perform communication with a first server that stores an electronic document, a second server that stores a recorded program, and a third server that stores keyword information associated to the recorded program; a user interface configured to accept an operation made by a user; and a controller configured to cause a display screen to display the electronic document acquired from the first server. The controller transmits, in response to a selection made by the user, information relevant to selected contents in the electronic document to the third server; acquires, from the third server, information specifying at least one recorded program associated to keyword information matching to, or similar to, the transmitted information; and reproduces the recorded program stored on the second server.

In another general aspect, an information processing device disclosed herein includes a network interface configured to perform communication with a first server that stores an electronic document and a second server that stores at least one type of data among moving image data, still image data and document data which are associated to keyword information; a user interface configured to accept an operation made by a user; and a controller configured to cause a display screen to display the electronic document acquired from the first server. The controller transmits, in response to a selection made by the user, information relevant to selected contents in the electronic document to the second server; acquires, from the second server, at least one type of data among moving image data, still image data and document data which are associated to keyword information matching to, or similar to, the transmitted information; and causes the display screen to display at least one of the moving image, the still image and the document together with the electronic document.

According to the above aspects, information relevant to a part, of an electronic document, selected by user is displayed on a display screen. Therefore, the user can acquire information on a recorded program or the like relevant to the part of the electronic document in which he/she is interested, easily and in a timely manner.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 shows a structure of the entirety of an electronic document display system in Embodiment 1.

FIG. 2 shows an example of document structure of an HTML document.

FIG. 3 is a flowchart showing an electronic document display method in Embodiment 1.

FIG. 4 shows an example of list of scenes of recorded programs, scene time and keywords of the recorded programs, which are stored on a third server or a fifth server.

FIG. 5 shows an example of list of breaking news displayed on a display screen of an electronic document display device.

FIG. 6 shows an example of an article of the breaking news displayed on the display screen of the electronic document display device.

FIG. 7 shows an example of display of a reproduction button for reproducing a recorded program relevant to an article in the breaking news displayed on the display screen of the electronic document display device.

FIG. 8 shows a structure of the entirety of an electronic document display system in a modification of Embodiment 1.

FIG. 9 is a flowchart showing an electronic document display method in the modification of Embodiment 1.

FIG. 10 shows a structure of the entirety of an electronic document display system in Embodiment 2.

FIG. 11 is a flowchart showing an electronic document display method in Embodiment 2.

FIG. 12 shows an example of electronic book displayed on a display screen of the electronic document display device.

FIG. 13 shows an example of display of a reproduction button for reproducing a recorded program relevant to a prescribed part of the electronic book displayed on the display screen of the electronic document display device.

FIG. 14 shows another example of display of a reproduction button for reproducing a recorded program relevant to a prescribed part of the electronic book displayed on the display screen of the electronic document display device.

FIG. 15 shows an example of display presenting displaying a list of breaking news in Embodiment 3.

FIG. 16 shows an example of display presenting a menu of transmission services in Embodiment 3.

FIG. 17 shows an example of display of an electronic book in Embodiment 3.

FIG. 18 shows another example of display presenting a menu of transmission services in Embodiment 3.

FIG. 19 shows a structure of the entirety of an electronic document display system in Embodiment 4.

FIG. 20 is a flowchart showing an electronic document display method in Embodiment 4.

FIG. 21 shows an example of change of a display presenting a list of breaking news in Embodiment 4.

FIG. 22 shows an example of change of a display presenting an electronic document in Embodiment 4.

### DETAILED DESCRIPTION

Hereinafter, embodiments will be described in detail with reference to the drawings when necessary. Descriptions may not be provided in detail more than necessary. For example, matter already well known may not be described in detail, or substantially the same structure may not be repeatedly described. This is for the purpose of avoiding unnecessary redundancy and allowing a person of ordinary skill in the art to understand this disclosure easily. The inventors provide the attached drawings and the following description in order to allow a person of ordinary skill in the art to fully understand the present disclosure, and do not intend to limit the subject matter of the claims in any way.

### Embodiment 1

First, Embodiment 1 will be described. This embodiment is regarding an electronic document display system including an information processing device capable of displaying contents of electronic newspaper (hereinafter, may be referred to as “newspaper contents”) on a display screen. The information processing device is capable of displaying contents of a broadcast program recorded on a recorder (recording device) or video contents provided in a video on command (VOD) format (hereinafter, these contents may be generically referred to as a “recorded program”) on a display screen, as well as the newspaper contents. In addition, when a user selects a part in which he/she is interested from the newspaper contents that he/she is browsing, the information processing device reproduces a recorded program relevant to the part. In order to realize this function, the information processing device has a structure communicable to a first server for holding newspaper contents, a recorder for holding a recorded program (second server), and a third server for holding keyword information associated to the recorded program, via a network.

In this specification, the term “server” refers to a computer (encompassing a device including a computer) capable of recording data and transmitting/receiving data or a combination of a plurality of such computers. In this embodiment, the first server and the third server are server computers owned by different business entities, and the second server is a recorder owned by a user or a server computer owned by a business entity. However, the servers are not limited to such an example.

When the information processing device transmits tag information embedded in the part of the newspaper contents selected by the user or text information of the part to the third server, the third server searches for a recorded program having keyword information matching to, or similar to, the tag information or the text information. When there is a recorded program having keyword information matching to, or similar to, such information, the third server transmits information specifying a scene of the recorded program (e.g., program ID or reproduction start time) to the information processing device. Upon receipt of the information, the information processing device acquires data on the recorded program corresponding to the information from the second server, and reproduces the recorded program. Owing to this, when the user wishes to understand an article or a term more profoundly while browsing electronic newspaper, the user can view a recorded program relevant to the article or the term easily and in a timely manner.

With a conventional information processing device, the user can conveniently read breaking news, or evening paper of the day or the morning paper of the next day which is scheduled to be distributed after the breaking news. However, it is not interesting enough to merely read a text or see an image of the newspaper. The user may feel that he/she cannot fully understand the article merely with the text information or image information of the newspaper. There may be a user who wishes to understand the article in a multifaceted manner by organically combining the newspaper article and relevant information such as moving image information or the like.

Meanwhile, a recording method referred to as “all program recording” is now spreading. By “all program recording”, all the TV programs for a specified number of days (e.g., for one week) of all the channels are recorded by use of a multichannel recorder for recording all such programs (hereinafter, such a multichannel recorder may be referred to as an “all program recorder”) is now spreading. However, no method has yet been found for effectively utilizing the programs recorded by all program recording, and some users feel that they are forced to view and thus cannot enjoy the recorded programs, or even that they cannot finish viewing the recorded programs.

As described above, there is a problem that even if the user, while reading a newspaper article by use of an information processing terminal, records a program relevant to the article, the user cannot view the recorded program in a timely manner. This problem is also applicable to reading of electronic documents such as books, magazines, academic journals and the like as well as newspaper articles.

In the case where a recorded program relevant to an electronic document that the user is browsing is not the program recorded by the user but is stored on, for example, a server on the Internet, the user may wish to view such a recorded program in a timely manner.

According to a system in this embodiment, a recorded program relevant to an article or a language in the newspaper contents can be easily specified and made viewable in a timely manner. Thus, the system in this embodiment is highly convenient to the user. Hereinafter, a structure and an operation in this embodiment will be described more specifically.

[1-1. Structure]

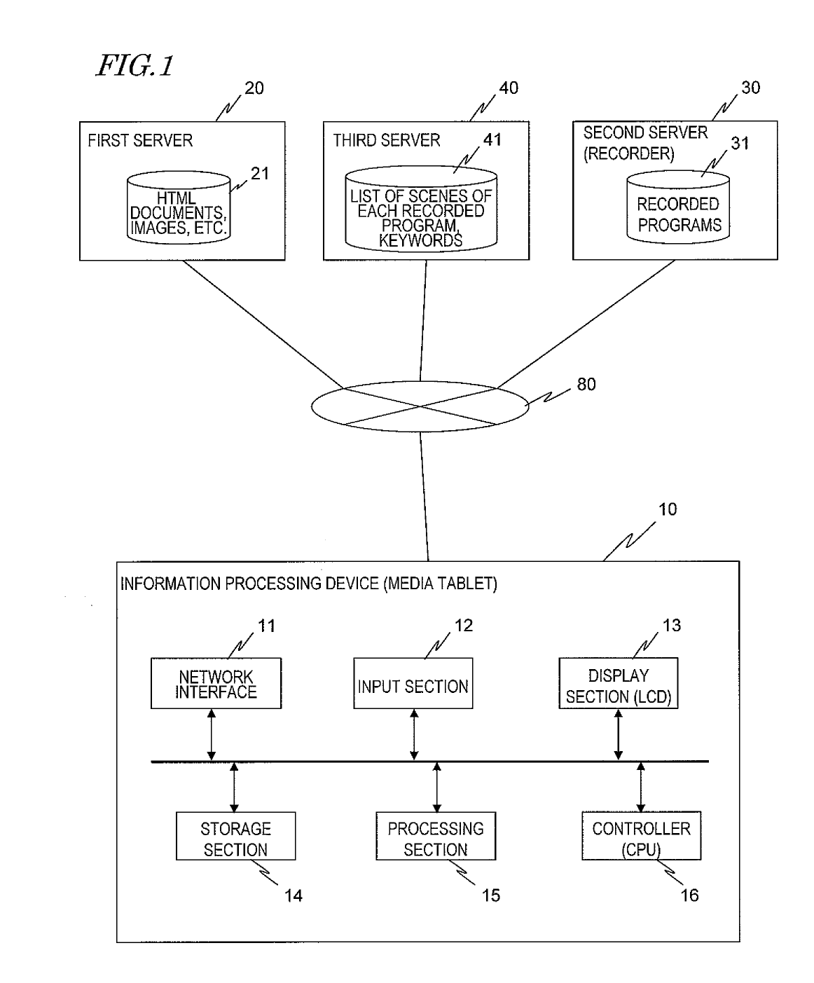

FIG. 1 shows a structure of the entirety of an electronic document display system in this embodiment. This system includes a first server 20, a second server (recorder) 30, a third server 40, and an information processing device 10 which are connected to a network 80.

In this embodiment, electronic newspaper (newspaper contents) will be described as an example of electronic document. Thus, the information processing device 10 is an electronic newspaper display device.

The information processing device 10 is a user terminal such as a PC (personal computer), a smartphone or the like, which can display breaking news (also referred to as “latest news”), and evening paper of the day or the morning paper of the next day which is electronic newspaper (newspaper contents) distributed after the arrival of the breaking news. Herein, the information processing device 10 is a media tablet. The “contents” of evening paper or morning paper which are included in electronic newspaper encompass information such as a list of headlines, newspaper image and the like.

The media tablet 10 is connectable to the first sever 20, the second server (recorder) 30 and the third server 40 via the communication network 80 in a wired or wireless manner.

The first server 20 is managed by an information distribution company such as a newspaper publishing company or the like, and accumulates therein information such as HTML documents, images and the like which are included in breaking news or newspaper contents such as morning paper, evening paper, or the like. In compliance with a request from the media tablet 10 including a web browser, the first server 20 distributes breaking news or electronic newspaper via the communication network 80.

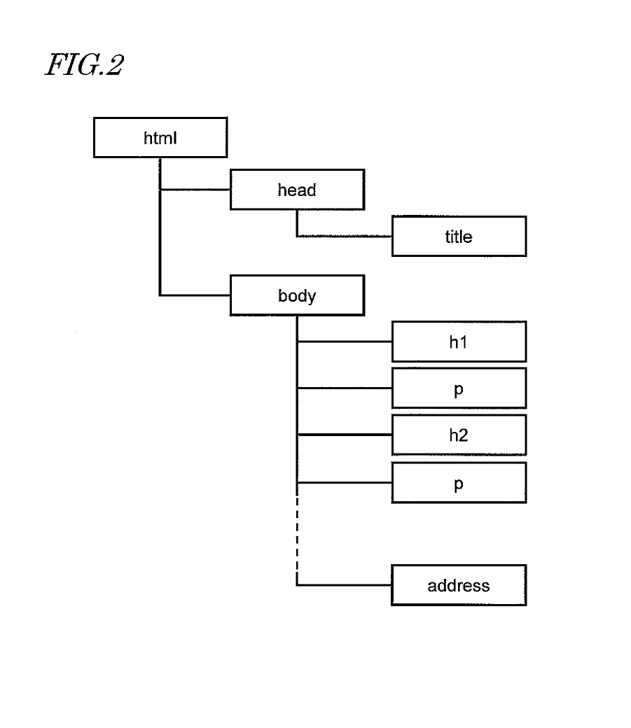

FIG. 2 shows an example of data structure of an HTML document included in electronic newspaper. The HTML document included in electronic newspaper which is accumulated in a storage section 21 of the first server 20 has a data structure as shown here. The HTML document is a combination of elements (parts) such as a title, a headline, a paragraph and the like. “HTML” is a method of presenting elements by enclosing a part of a document by use of a special character string called “tag”, which is held between “<” and “>”. According to HTML, information on a structure or modification of an article can be embedded in the document. Also according to HTML, the end of a title or a paragraph in an article can be specified; or an image, a sound or a moving image can be embedded as a part of the document.

The browser finds a tag from the HTML data, and identifies which part is the title and which part is the paragraph to display the article. In the example of FIG. 2, an html element includes a head element and a body element. The head element and the body element each include a different element(s). In the case where the elements have such a relationship, an outer element is referred to as a “parent element”, and an element included therein is referred to as a “child element”. One document can be represented as having a tree structure which starts with the html element. More specifically, a parent element is branched into child elements, which are further branched into child elements thereof. In this manner, electronic newspaper is constructed by use of an HTML document. Alternatively, electronic newspaper may be constructed by use of an XML document.

The second server 30 may be a recorder owned by a user of the media tablet 10 (encompassing a family member of the user), or may be a dedicated server which is managed by a corporation such as a broadcast business entity or the like, and records a program and provides the recorded program. Herein, the second server 30 is an all program recorder owned by a user and is connectable to the Internet. The recorder holds a plurality of recorded programs in a storage section 31 thereof.

The third server 40 is managed by an information management company. In a storage section 41 thereof, the third server 40 holds a list of scenes of each of the plurality of recorded programs stored on the storage section 31 of the recorder 30, and also holds keyword information, scene time information and the like accompanying the scene. The third server 40 receives breaking news or article information in the electronic newspaper (encompassing text information of the newspaper article) from a network interface (transmission section) 11 of the media tablet 10. Upon receipt thereof, the third server 40 searches for a recorded program having a keyword matching to, or similar to, a keyword used in the article, by use of the text information of the breaking news or the electronic newspaper.

The media tablet 10 includes an input section (operation section) 12 having a touch sensor or a hardware button which is operable by the user to make various operations such as a tap operation, an input operation and the like; a display (display section) 13 having an LCD (liquid crystal display) of the like for displaying characters of breaking news or an newspaper image on a display screen thereof; a storage section 14 such as a hard disc drive (HDD) or the like for storing character data of the breaking news or image data of the newspaper image to be displayed; a controller (CPU) 16, and the like. The controller 16 receives recorded program information (recorded program ID) having a keyword matching to, or similar to, a keyword used in an article in electronic newspaper from the third server 40. Upon receipt thereof, the controller 16 causes the display section 13 to display a reproduction button usable for reproducing a recorded program relevant to the article in the electronic newspaper based on the recorded program information.

The character data of the breaking news, the image data of the newspaper article or the like to be displayed is captured by the storage section 14 from the storage section 21 of the first server 20 via the communication network 80 such as a public wireless LAN service or the Internet and via the network interface (receiving section) 11. Then, in compliance with an operation made by the user, the data is transferred to the controller 16 via the input section 12. In compliance with an instruction from the controller 16, the web browser causes the display section 13 to display the characters of the breaking news or the image of the newspaper image on the display screen, by use of a processing section 15.

In this embodiment, the controller 16 is implemented by a CPU for executing a program stored on the storage section 14. Alternatively, the controller 16 may be implemented by dedicated software. The display section 15 may be implemented by a general-purpose graphics controller or the like.

The media tablet 10 has a “breaking news list display mode” of displaying a list of breaking news, a “breaking news details display mode” of displaying the details of the breaking news”, a “headline list display mode” of displaying a list of headlines of electronic newspaper such as morning paper, evening paper or the like, and “newspaper image display mode” of displaying a newspaper image of electronic newspaper. The user can switch the display mode by use of a dedicated button on the media tablet 10 or a specific position on the display screen (where a button or the like is displayed).

[1-2. Operation]

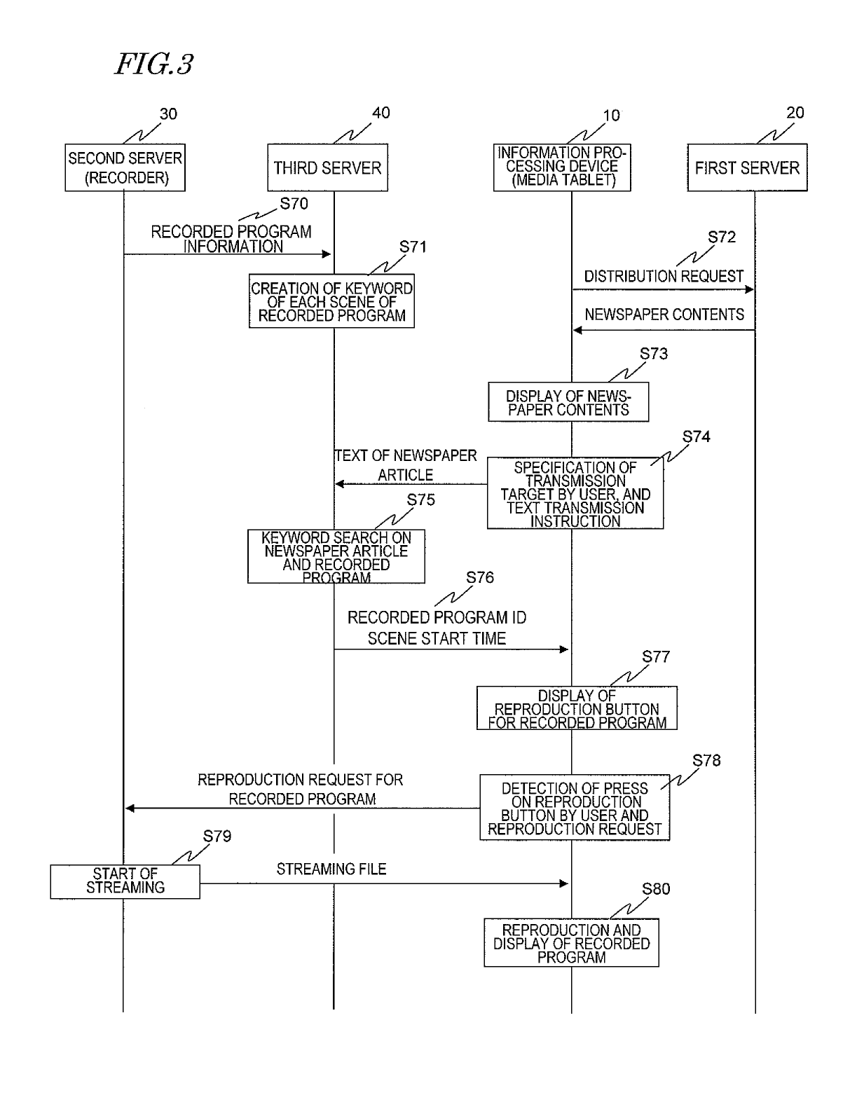

Now, an electronic newspaper display method in the electronic newspaper display system will be described. FIG. 3 is a flowchart showing the electronic newspaper display method.

In step S70, the recorder 30 sends information on programs recorded by the recorder 30 by all program recording (recorded program ID) to the third server 40. This step may be executed automatically at a predetermined time interval or may be executed manually.

In step S71, the third server 40 specifies recorded programs by use of a plurality of received recorded program IDs, and, for example, creates a keyword of each of scenes of the recorded programs. The creation of the keyword of each of scenes of the recorded programs is performed manually or mechanically. According to one method for attaching a keyword mechanically, a keyword is extracted by use of sounds, subtitles or the like of the recorded program. According to one method for attaching a keyword manually, a person in charge of the information management company edits keywords of each individual recorded program when necessary. The third server 40 stores a list of scenes of the recorded programs corresponding to the received recorded program IDs, a keyword of each scene created as described above manually or mechanically, and information representing the start time of each scene on the storage section 41.

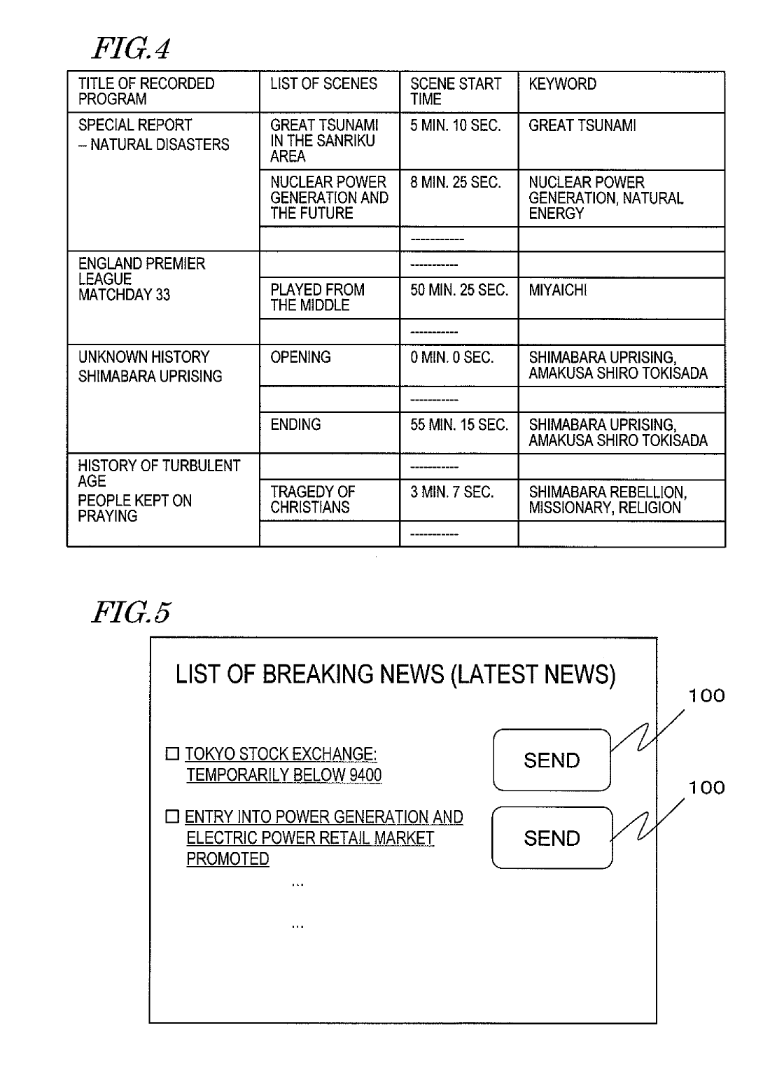

FIG. 4 shows a specific example of information stored on the storage section 41 of the third server 40. As shown in FIG. 4, the storage section 41 stores therein a table which shows titles of the recorded programs held by the recorder 30, a list of scenes of each recorded program (title of each scene), and the start time and the keyword of each scene. In addition to the items shown in FIG. 4, the recorded program IDs and other necessary information may be stored.

In step S72, the media tablet 10 requests the first server 20 to distribute breaking news or electronic newspaper (newspaper contents) such as morning paper, evening paper or the like. As a result, the network interface 11 of the media tablet 10 receives the breaking news or the newspaper contents such as morning paper, evening paper or the like from the first server 20. Next, in step S73, the controller 16 of the media tablet 10 has a list of breaking news and a transmission button (described later) displayed on the display screen.

FIG. 5 shows an example of list of breaking news displayed on the display screen of the display section 13 of the media tablet 10. In the breaking news list display mode, a list of breaking news (latest news) is displayed as shown in FIG. 5. To the right thereof, a transmission button 100 is also displayed in correspondence with the headline of each article. The user taps a part of the headline of the article that he/she wishes to browse (e.g., a part of the headline “Entry into power generation and electric power retail market promoted” in the list of breaking news. When the user taps such a part, the display mode is switched to the breaking news details display mode, and the user can read the details of the selected article.

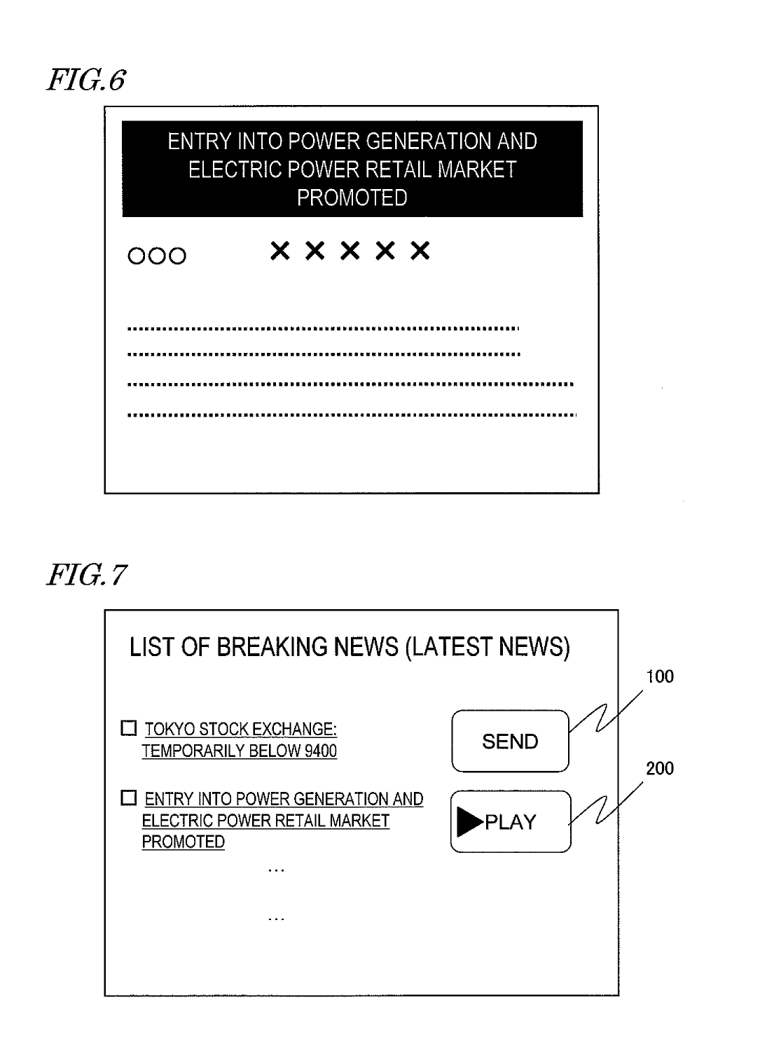

FIG. 6 shows an example of display screen in the breaking news details display mode. When the user selects the article “Entry into power generation and electric power retail market promoted”, the display screen is switched to the display screen which presents the details of the article as shown in FIG. 6. This display screen may present an image such as a photograph or the like in addition to the headline and the detailed contents of the article. The user can have the detailed article displayed as shown in FIG. 6 for each of the headline. Although not shown in FIG. 6, the user may tap a button for returning the display screen to the immediately previous display screen so that the list of breaking news is displayed.

The user may feel that he/she does, not fully understand the newspaper article merely with the text information and the image information of the newspaper. step S74, when the user taps the transmission button 100, the network interface 11 of the media tablet 10 transmits, to the third server 40, text information included in the information of the article selected by the user among the articles shown in FIG. 5. In the case where tag information is embedded in each of the articles of the newspaper contents in advance, the tag information may be transmitted instead of the text information. For example, a keyword can be embedded for each piece of breaking news by use of an Object tag of HTML.

In step S75, upon receipt of the text information of the newspaper article sent from the network interface 11 of the media tablet 10, the third server 40 searches for a recorded program having a keyword matching to, or similar (relevant) to, the keyword used in the text of the breaking news (in this example, the keywords are “power generation” and “electric power”), by use of the list of scenes of each of the recorded programs recorded by the user by the recorder 30 and the keyword information set for each of the scenes. The list of scenes and the keyword information are stored on the storage section 41. Namely, as a keyword search in the third server 40, a matching word search and/or similar word search is performed. As a result, one or a plurality of scenes of recorded programs having a matching or similar keyword can be specified. In the example of FIG. 4, as a recorded program relevant to the article of the breaking news, a recorded program having a keyword partially matching to the keyword “power generation”, namely, “Special report—natural disasters” is specified. More specifically, a scene in this program starting at time 8 min. 25 sec., namely, “Nuclear power generation and the future” is specified.

In step S76, the third server 40 transmits reproduction time information of the scene(s) of one or a plurality of recorded programs (recorded program IDs and start time of the scene(s)) to the media tablet 10. Then, in step S77, the controller 16 of the media tablet 10 causes the display section 13 to display a reproduction button 200. The reproduction button 200 is usable for reproducing the recorded program, stored on the storage section 31 of the recorder 30, having a keyword matching to, or relevant to, the keyword of the article selected by the user. In this step, as shown in FIG. 7, the controller 16 causes the display section 13 to display the reproduction button 200 by use of the processing section 15, such that the reproduction button 200 positionally replaces the transmission button 100.

As a result of this process, the user learns that there is a recorded program relevant to the newspaper article selected by him/her, among the programs recorded by all program recording by the recorder 30 owned by the user. In step S78, when the user taps the reproduction button 200, the media tablet 10 transmits the recorded program ID of the recorded program to be reproduced and the information of the scene start time to the recorder 30, and thus requests the recorder 30 to reproduce the recorded program.

In step S79, in compliance with the reproduction request made in step S78, the recorder 30 transfers a streaming file including the requested scene(s) of the recorded program. In step S80, the media tablet 10 receives the streaming file via the network interface 11, and the processing section 15 executes streaming-type application software to decode the streaming file. Then, the media tablet 10 causes the display section 13 to display the reproduced moving image of the recorded program transferred as the streaming file on the display screen.

In the above, an article of breaking news is described as an example. A specific article of electronic newspaper can be processed in substantially the same manner. For example, in the case where the media tablet 10 is structured such that when the user selects a random part of a specific article by a drag operation or the like, a text of this part is transmitted to the third server 40, substantially the same process as above can be performed. Alternatively, in the case where a keyword is embedded in advance in an article of electronic newspaper, the tag information may be transmitted to the third server 40.

[1-3. Effects, etc.]

As described above, the electronic document display system in this embodiment includes the first server 20 for holding an electronic document, the second server 30 for holding a recorded program, the third server 40 for holding keyword information associated to the recorded program, and the information processing device 10. The information processing device 10 includes the network interface 11 for performing communication with the first server 10, the second server 20 and the third server 30, the input section 12 which is a user interface for accepting an operation made by the user, and the controller 16 for causing the display screen (display section) 13 to display the electronic document acquired from the first server 20. In response to the a selection made by the user, the controller 16 transmits information relevant to the selected contents in the electronic document. Then, the controller 16 acquires, from the third server 40, information (recorded program ID and information of the scene start time) specifying at least one recorded program associated to keyword information matching to, or relevant to, the transmitted information, and reproduces the recorded program stored on the second server 30. As a result, the user can view the recorded program relevant to the part of the newspaper contents in which he/she is interested, easily and in a timely manner.

Especially in this embodiment, the reproduction button 200 reproducing a recorded program relevant to the article in the newspaper contents is displayed on the display screen. Therefore, the user can specify the recorded program relevant to the article in the newspaper contents more easily. Moreover, the user can view the recorded program in a timely manner.

The keyword information is associated to each of the scenes included in the recorded program. Therefore, the controller 16 can acquire, from the third server 40, information specifying a scene associated to keyword information matching to, or similar to, the information transmitted to the third server 40. As a result, only a scene which is especially highly relevant to the part of the article in which he/she is interested can be reproduced.

[1-4. Modifications]

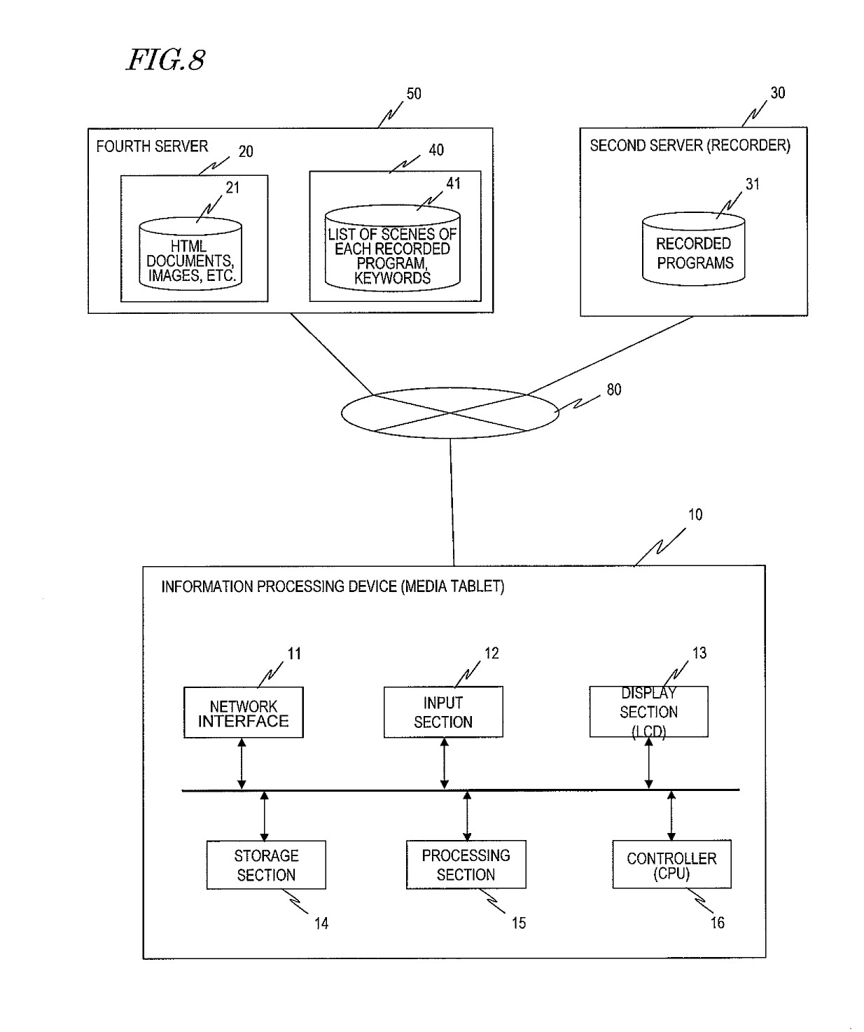

In this embodiment, the electronic document display system includes the first server 20, the second server 30 and the third server 40, which are different from one another. The electronic document display system is not limited to such a structure. Two of, or all of, the three servers may be implemented by one device. For example, as shown in FIG. 8, the electronic document display system may include a fourth server 50 having the functions of the first server 20 and the third server 40, the second server 20 and the information processing device 10. Alternatively, the electronic document display system may include one server having the functions of the first through third servers 20 through 40, and the information processing device 10.

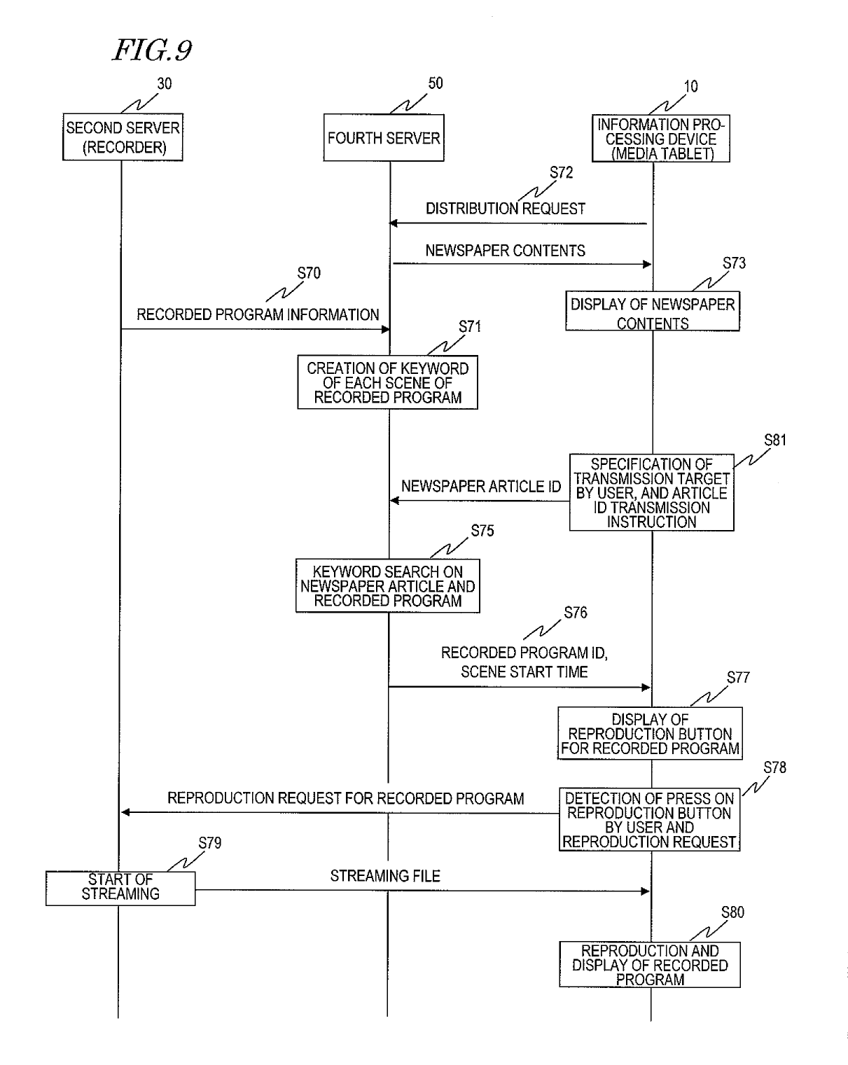

FIG. 9 is a flowchart showing an operation of the entire system in the example of structure shown in FIG. 8. In the example of FIG. 8, the electronic newspaper is displayed and the recorded program is reproduced in accordance with the flowchart shown in FIG. 9, which is different from the flowchart shown in FIG. 3. Main difference between FIG. 9 and FIG. 3 are that the operations of the first server 20 and the third server 40 in FIG. 3 are combined into the operation of the fourth server 50, and step S74 is replaced with step S81.

Hereinafter, these differences will be mainly described. The media tablet 10 requests the third server 40 to distribute the newspaper contents and to send the recorded program information. In step S81, the network interface 11 of the media tablet 10 transmits an article ID, instead of the text information in the newspaper contents to the fourth server 50. Upon receipt of the article ID, the fourth server 50 specifies the text included in the article corresponding to the article IDs, among the articles stored on the storage section 21 of the fourth server 50. As a result, like in FIG. 3, a recorded program having a keyword matching to, or relevant to, a keyword used in the text in the article is specified, by use of the list of scenes of each of the recorded programs and the keyword information set for each of the scenes as shown in FIG. 4. The list of scenes and the keyword information are stored on the storage section 31.

As described above, in the structure shown in FIG. 8 and FIG. 9, the server for distributing the newspaper contents and the server for managing the program information are both implemented by the fourth server 50. Therefore, the extraction of a text in the newspaper contents and the specification of a recorded program relevant to the text can be performed efficiently. Such a structure can also realize the functions substantially the same as those of the structure shown in FIG. 1 and FIG. 3.

This embodiment adopts a client-directed method (smart pull type method), by which the user (media tablet 10) requests the first server 20 to distribute breaking news or electronic newspaper. The same effects are provided by a server-directed method (real push type method), by which the first server 20 distributes breaking news at appropriate timings and also distributes electronic newspaper such as morning paper, evening paper or the like at fixed times.

In this embodiment, the keyword information owned by the third server 40 is associated to each of scenes included in the recorded program. The keyword information is not limited to this, and may be associated to each recorded program.

### Embodiment 2

In Embodiment 1, an example of electronic document display system including the information processing device for displaying electronic newspaper (newspaper contents) as an electronic document is described. In this embodiment, a system including an information processing device for displaying an electronic document other than the newspaper contents, such as a book, a magazine, an academic journal or the like, will be described.

[2-1. Structure]

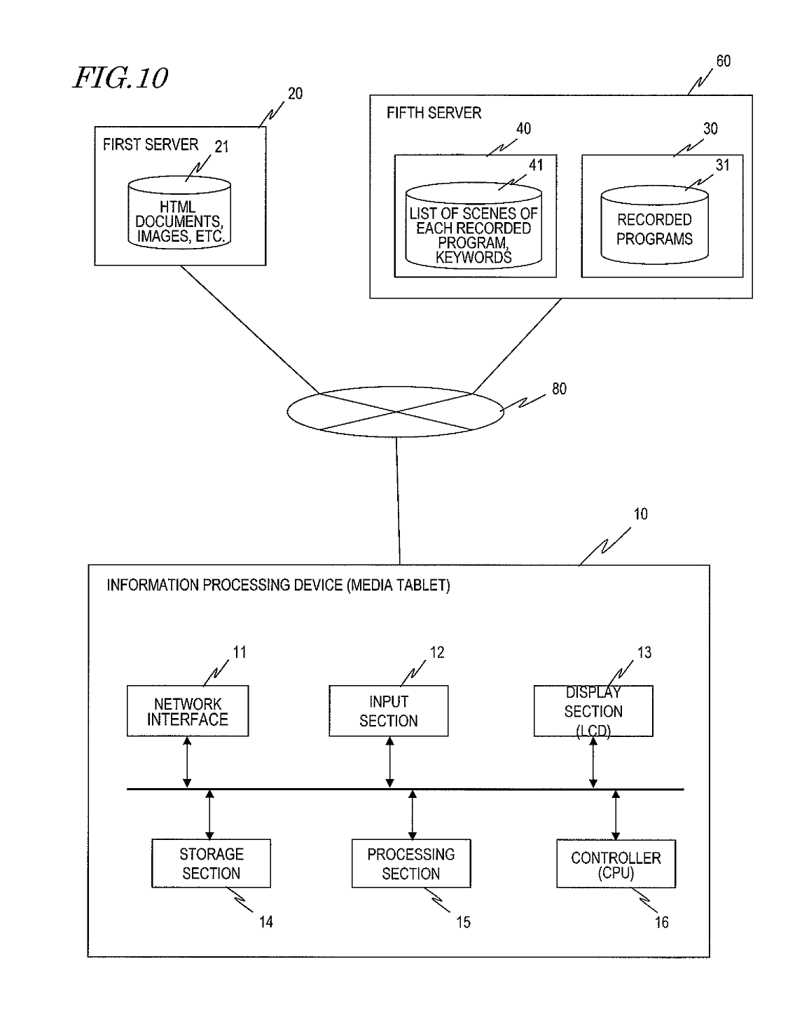

FIG. 10 shows a structure of the entirety of an electronic document display system in this embodiment. In this embodiment, the first server 20 distributes an electronic document other than newspaper contents, such as a book or the like. The second server 30 and the third server 40 are combined into a fifth server 60 and is managed by one business entity. The information processing device 10 shown in FIG. 10 has the same structure as that of the information processing device 10 shown in FIG. 1, and may display an electronic document such as a book, a magazine, an academic journal or the like as well as newspaper contents. Hereinafter, differences from FIG. 1 will be mainly described.

The information processing device 10 is a media tablet in this embodiment also, but may be another information processing device such as a PC or a smartphone.

The media tablet 10 is connectable to the first server 20 and the fifth server 60 via the communication network 80 in a wired or wireless manner.

The first server 20 is managed by an information distribution company such as a publishing company or the like, and accumulates, in the storage section 21, information files such as PDF files, HTML documents, images and the like which are included in an electronic document such as a book, a magazine, an academic journal or the like. In compliance with a request from the media tablet 10 including a web browser, the first server 20 distributes an electronic document via the communication network 80.

The fifth server 60 is managed by a broadcasting company, an information management company or the like, and holds, in the storage section 41, a list of scenes of a plurality of recorded programs stored on the storage section 31, and keyword information, scene start time and the like accompanying each of the scenes. Upon receipt of text data information or tag information on a selected part of the electronic document from the network interface (transmission section) 11 of the media tablet 10, the fifth server 60 searches for a recorded program having a keyword matching to, or relevant to, a keyword used in the part, by use of the text information or tag information.

[2-2. Operation]

Now, a method for displaying an electronic document by the electronic document display system in this embodiment will be described.

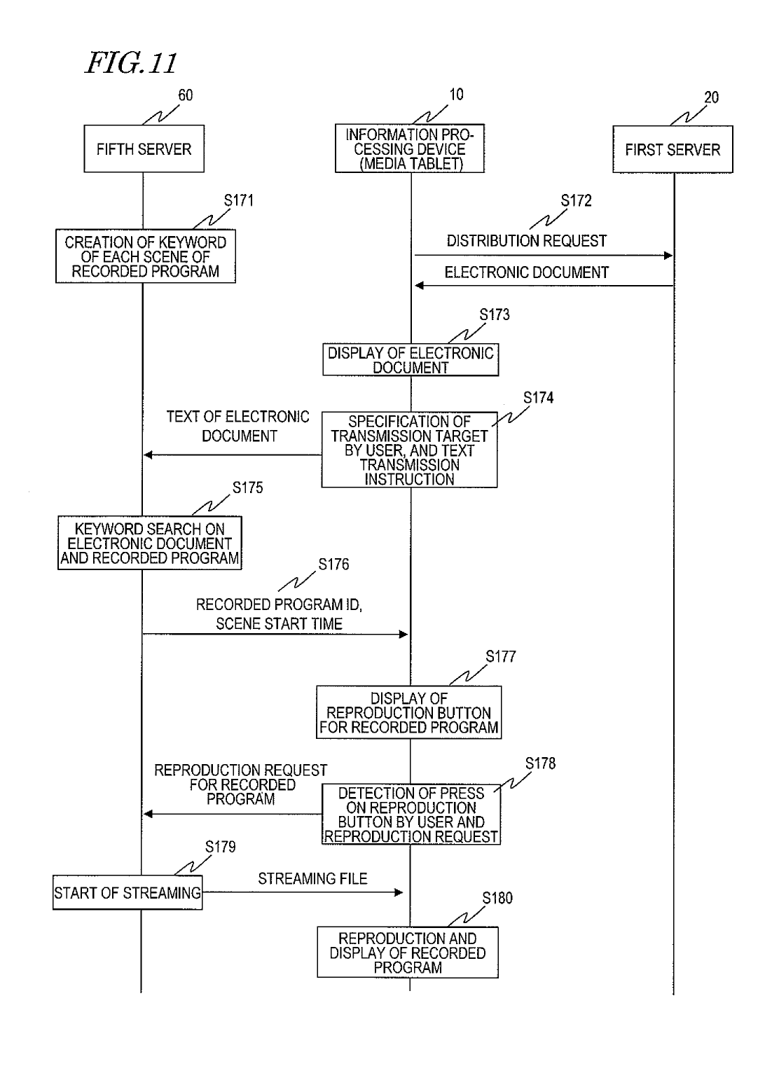

FIG. 11 is a flowchart showing the electronic document display method.

In step S171, the fifth server 60 creates keyword information of each of the scenes of the recorded programs stored on the storage section 31. The fifth server 60 creates the list of scenes of the recorded programs stored on the storage section 31 and information defining the keyword and the scene start time of each scene manually or mechanically, and stores the created list of scenes and information on the storage section 41. The information stored on the storage section 41 of the fifth server 60 is, for example, substantially the same as the table shown in FIG. 4.

In step S172, the media tablet 10 requests the first server 20 to distribute an electronic document. As a result, the network interface 11 of the media tablet 10 receives the electronic document from the first server 20. Next, in step S173, the controller 16 of the media tablet 10 causes the display section 13 to display contents of a prescribed page of the electronic document and a transmission button (described later) on the display screen, by use of the processing section 15.

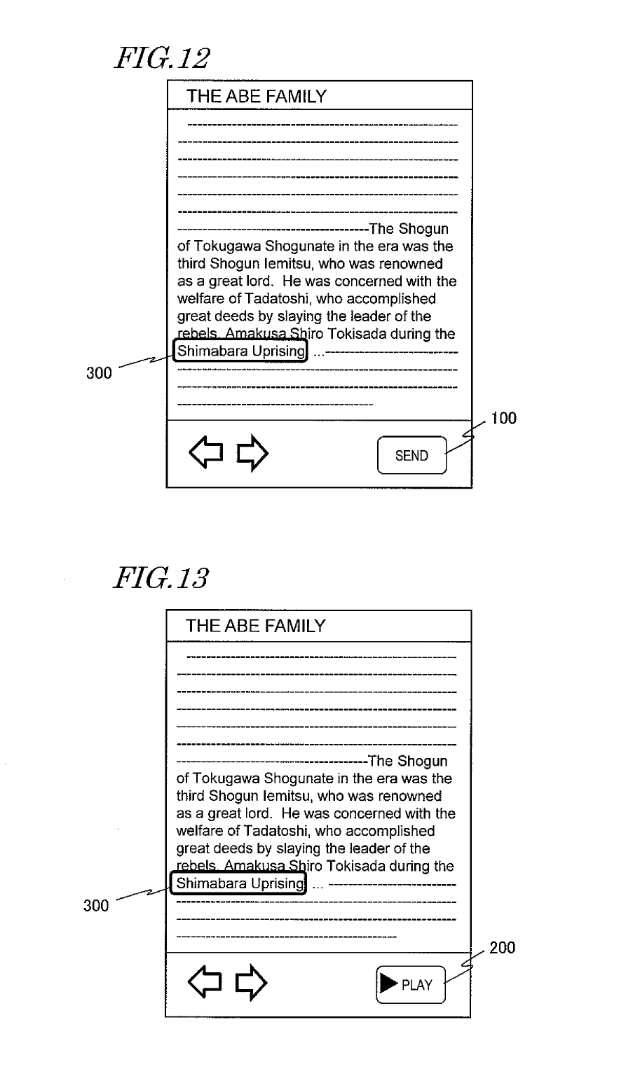

FIG. 12 shows an example of electronic document displayed on the display screen of the media table 10. In the example of FIG. 12, a page of the novel “The Abe Family” written by Mori Ogai is displayed on the display screen, and the transmission button 100 is displayed below the page.

The user may get interested in a specific event while reading an electronic book. In step S174, in the case where the user gets interested in an event (in this example, “Shimabara Uprising”), the user selects or copies the letters “Shimabara Uprising” 300 by a drag operation and taps the transmission button 100 to transmit the text information of “Shimabara Uprising” to the fifth server 60. In this embodiment also, tag information embedded in the electronic book, instead of the text information, may be transmitted. For example, in the case where the electronic book is provided by EPUB, which is one format of electronic books, a keyword can be embedded by use of an Object tag. Alternatively, a specific keyword may be selected from a group of keywords embedded in the document.

In step S175, upon receipt of the text information of the newspaper article sent from the network interface 11 of the media tablet 10, the fifth server 60 checks the text information against the keyword information of the recorded programs to search for a recorded program relevant to the text information. Specifically, the fifth server 60 searches for a recorded program having a keyword matching to, or similar to, the keyword used in the text in the electronic book (in this example, “Shimabara Uprising”), by use of the list of scenes of each of the recorded programs and the keyword information set for each scene. The list of scenes and the keyword information are stored in the storage section 41. As a result of the search, one or a plurality of scenes of recorded programs having a matching or relevant keyword can be specified. In the example of FIG. 4, a recorded program having the matching keyword “Shimabara Uprising”, namely, “Unknown history—Shimabara Uprising” is specified. More specifically, all the scenes from the “opening” starting at 0 min. 0 sec. to the “ending” starting at 55 min. 15 sec. are extracted. Also, a recorded program associated to a keyword “Shimabara Rebellion” similar to the keyword “Shimabara Uprising”, namely, “History of turbulent age—people kept on praying” is specified. More specifically, a scene in this program starting at time 3 min. 7 sec., namely, “Tragedy of Christians” is extracted.

In step S176, the fifth server 60 transmits the reproduction time information of the scene(s) of the plurality of specified recorded programs (recorded program IDs and information representing start time of the scene(s)) to the media tablet 10. Then, in step S177, the controller 16 of the media tablet 10 causes the display section 13 to display the reproduction button 200 as shown in FIG. 13, by use of the processing section 15. The reproduction button 200 is usable for reproducing a recorded program, stored on the storage section 31 of the recorder 30, having a matching or similar keyword. The reproduction button 200 is displayed so as to positionally replace the transmission button 100. In the example of FIG. 13, the reproduction button 200 for reproducing the recorded program “Unknown history—Shimabara Uprising” having a keyword closest to the keyword “Shimabara Uprising” specified by the user is displayed.

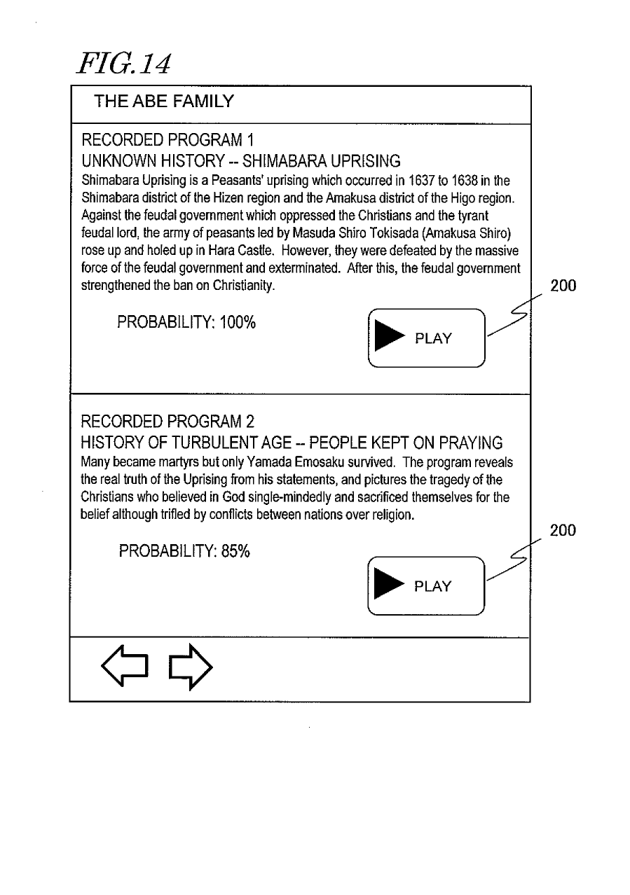

In the case where a plurality of recorded programs are extracted as described above, information on the plurality of extracted recorded program may be displayed as shown in FIG. 14. In the example of FIG. 14, for each extracted recorded program, the reproduction button 200 for reproducing the recorded program, the title and the outline of the recorded program, and the matching rate representing the degree of matching of the keywords are displayed. Owing to such display, the user learns that there are recorded programs relevant to the part of the electronic book selected by him/her. In the case of the display in FIG. 14, the user can learn the outline of the recorded program, and also can learn the degree of matching of the language specified by him/her and the keyword set for the scene of the recorded program based on the matching rate. This makes it easy for the user to determine which recorded program is to be reproduced, among the plurality of extracted recorded programs.

In step S178, when the user taps the reproduction button 200 for reproducing a prescribed recorded program, the media tablet 10 requests the fifth server 60 to reproduce the specified recorded program. In this step, the controller 16 of the media tablet 10 transmits, to the fifth server 60, the recorded program ID of the recorded program to be reproduced and the scene start time of the scene to be reproduced, and thus requests the fifth server 60 to reproduce the recorded program.

In step S179, in compliance with the reproduction request made in step S178, the fifth server 60 transfers a streaming file including the requested scene of the recorded program. In step S180, the media tablet 10 receives the streaming file via the network interface 11, and the processing section 15 executes streaming-type application software to decode the streaming file. Then, the media tablet 10 causes the display section 13 to display the reproduced moving image of the recorded program transferred as the streaming file on the display screen.

[2-3. Effects, etc.]

As described above, in this embodiment, regarding an electronic document other than newspaper, such as a book, a magazine, an academic journal or the like also, a relevant recorded program can be reproduced as in Embodiment 1. In this embodiment also, the reproduction button 200 for reproducing a recorded program relevant to the prescribed part of the electronic document is displayed. Therefore, the user can specify the recorded program relevant to the prescribed part of the electronic document easily. Moreover, the user can view the recorded program in a timely manner.

In this embodiment, when a plurality of recorded programs are extracted, the title and the outline of each recorded program and the matching rate representing the degree of matching of the keywords are displayed on the display screen of the media tablet 10, as well as the reproduction button 200. Alternatively, at least one of the outline of the recorded program and the matching rate may be displayed. Even when only one recorded program is extracted, the outline of the recorded program and/or the information representing the degree of matching of the keywords (matching rate) may be displayed on the display section 13. These manners of display are applicable to Embodiment 1.

In this embodiment, the functions of the second server 30 and the third server 40 are combined into the function of the fifth server 50. The electronic document display system is not limited to such a structure. Like in Embodiment 1, the first server 20, the second server 30 and the third server 40 may be implemented by different devices, or random two of, or all of, these devices may be implemented by one device. The first server 20, the second server 30 and the third server 40 may be managed by different business entities, or random two of, or all of, these devices may be managed by one business entity. Like in Embodiment 1, the second server 30 may be a recorder owned by the user.

### Embodiment 3

Now, Embodiment 3 will be described. This embodiment is regarding the information processing device 10 capable of displaying newspaper contents like in Embodiment 1. Unlike in Embodiment 1, the user can set a condition for recorded programs as search targets. Hereinafter, differences from Embodiment 1 will be mainly described.

[3-1. Structure]

The structure of the system and the structure of the information processing device 10 in this embodiment are substantially the same as those in Embodiment 1 (FIG. 1), and will not be described.

[3-2. Operation]

The overall flow of the operation in this embodiment is substantially the same as that in Embodiment 1 (FIG. 3). However, in this embodiment, the display screen shown in step S73 in FIG. 3 and the information set by the user in step S74 are different from those in Embodiment 1.

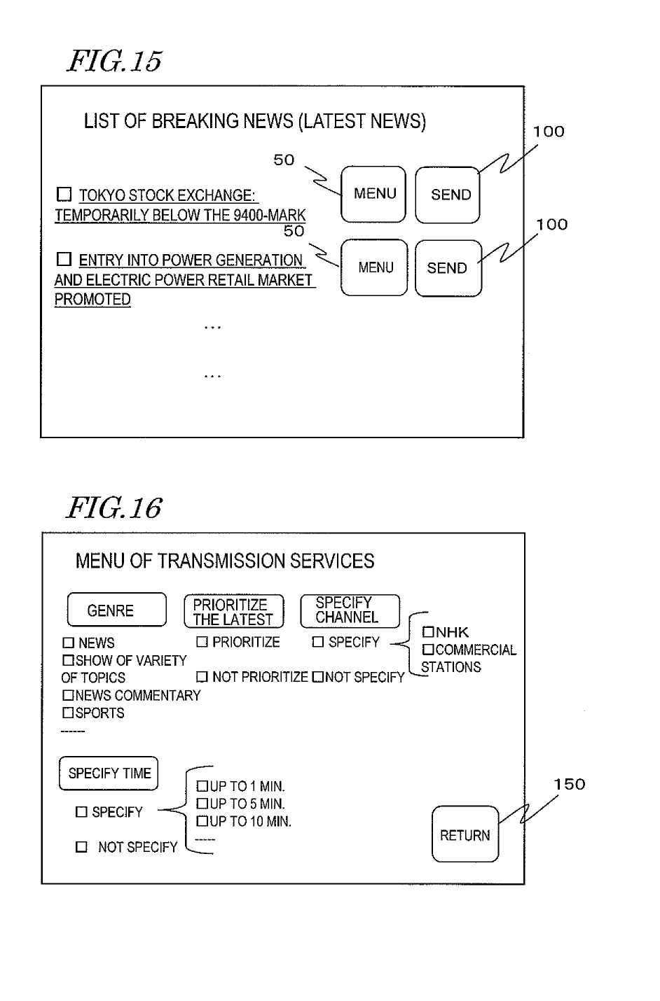

FIG. 15 shows a display screen of the information processing device 10 in this embodiment which displays a list of breaking news. In this embodiment, in step S73 shown in FIG. 3, the display screen shown in FIG. 15 is provided instead of the display screen shown in FIG. 5. In the display screen shown in FIG. 15, headlines of articles, a transmission button 100 for each headline, and also a menu button 50 for each headline are displayed. When the user taps the menu button 50, the display screen is changed to a display screen shown in FIG. 16 displaying a menu of transmission services. With this display screen, the user can set detailed search conditions. When the user taps a return button 150 in the display screen shown in FIG. 16, the display screen is changed back to the display screen shown in FIG. 15.

The user can set a search condition for any item in the menu shown in FIG. 16. The items for setting may include, for example, “genre”, “prioritize the latest”, “specify channel (CH)”, “specify time”, and the like. “Genre” may be, for example, news, show of variety of topics, news commentary, sports, and the like. Recorded programs of only the genre in which the user is interested, among these genres, can be made search targets. “Prioritize the latest” is used to set, in the case where the search result includes a plurality of recorded programs, whether or not to display only the recorded programs of the latest date. The recorded programs of the latest date may be made search targets, or alternatively, the recorded programs of a certain period of dates may be made search targets. “Specify channel” is used to make the recorded program of only specific channels search targets. For example, only the recorded programs of NHK (public broadcasting organization of Japan) or only the recorded programs of commercial stations can be made search targets. “Specify time” is used to set the length of the recorded programs to be reproduced. Owing to this, among the scenes of the recorded programs relevant to the article selected by the user, only the scenes having a certain length set here can be made search targets. The above-mentioned items are merely exemplary. It is sufficient that at least one item is provided as long as the user wishes to set a condition for recorded programs to be reproduced regarding that item.

The user sets such a search condition and taps the transmission button 100. In this embodiment, information representing the search condition is transmitted to the third server 40 together with the article information. The third server 40 transmits, to the information processing device 10, a program ID of a program matching the search condition, among the recorded programs relevant to the article information specified by the user, and information of the scene start time. As a result, only the recorded programs matching the condition wished by the user can be reproduced.

In the service menu, specified items may be set before the settings made by the user. For example, the service menu may be set to automatically provide the conditions matching the preferences of the user, based on various types of log data in the device (e.g., search history, etc.). When the user changes the setting, the specific contents of the setting may be stored, so as to be applied for the next search.

[3-3. Effects, etc.]

As described above, the controller 16 of the information processing device 10 in this embodiment causes the display screen to display at least item for setting a condition for recorded programs that the user wishes to reproduce. Owing to this, the user can narrow the recorded programs to be reproduced in accordance with his/her preferences, which can satisfy the user more.

In this embodiment, the controller 16 causes the display section 13 to display a menu button together with the electronic document; and when the user selects the menu button, the controller 16 causes the display section 13 to provide a display screen for setting a condition for recorded programs. Therefore, many items for setting the conditions for search targets can be displayed. As the number of items for setting is larger, the user can set the conditions in more detail. This increases the possibility that the search results matching the needs of the user is obtained.

In the case where the items displayed for setting the conditions include any one of the genre, channel and reproduction time length of program, the search targets can be narrowed based on such an item. This improves the usefulness.

[3-4. Modifications]

The above-described function of setting search conditions is also applicable to the information processing device 10 in Embodiment 2. Hereinafter, an example of information processing device 10 in such a case will be described.

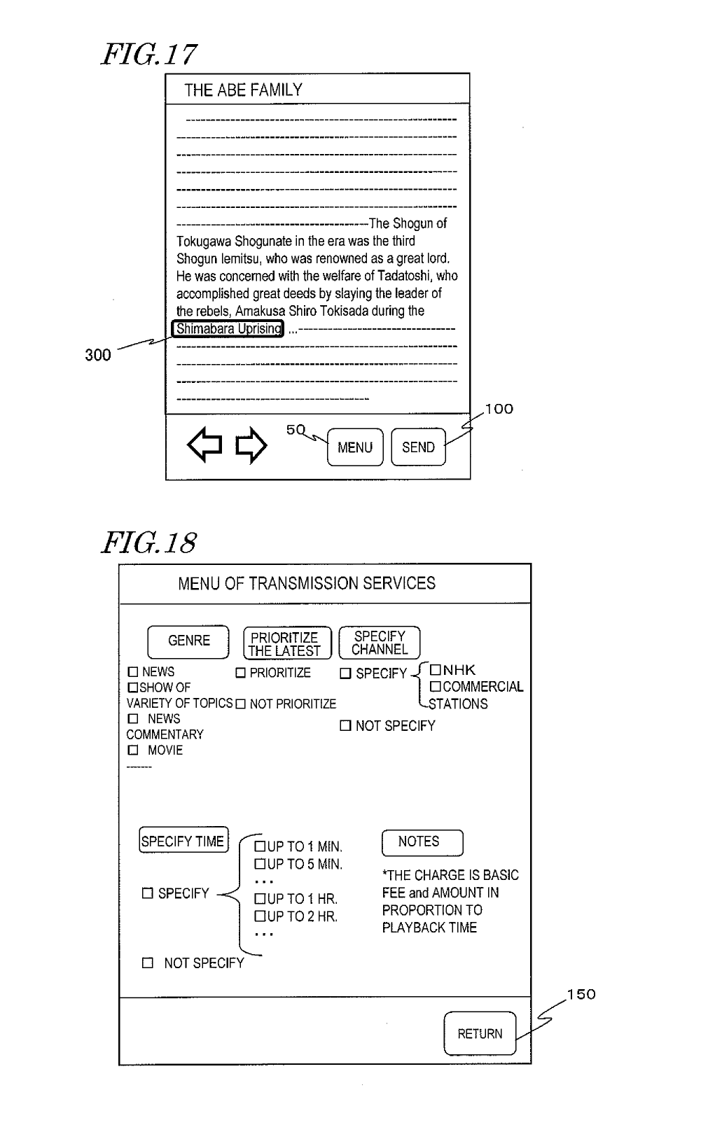

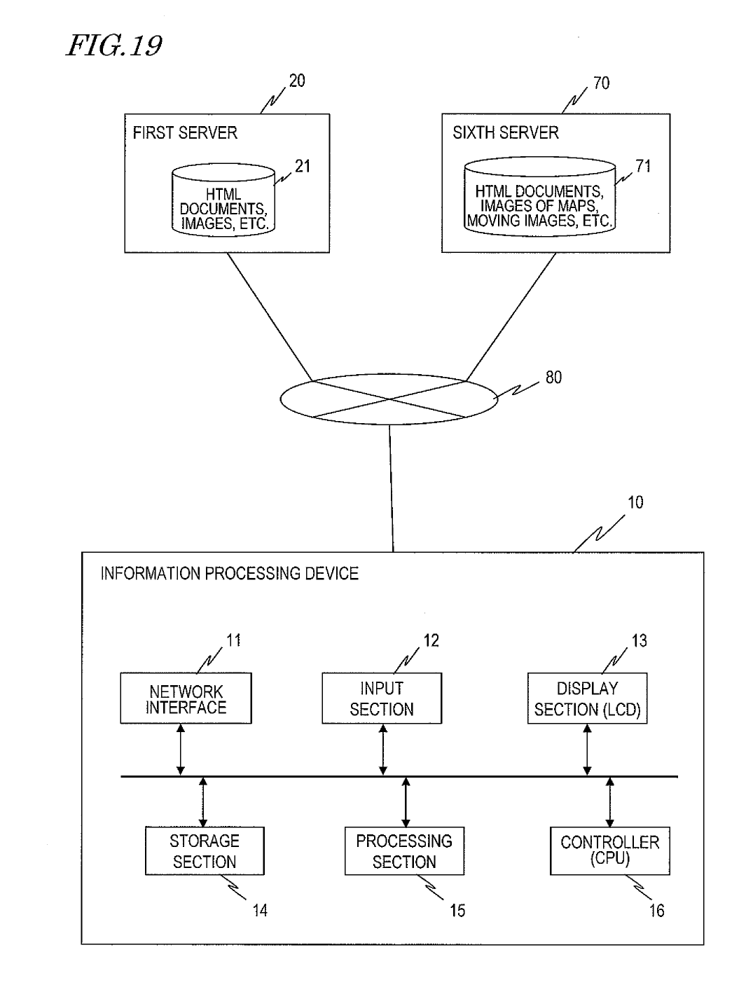

FIG. 17 shows a display screen of the information processing device 10 in this example which displays an electronic book. In this example, in step S173 shown in FIG. 11, the display screen shown in FIG. 17 is provided instead of the display screen shown in FIG. 12. In the display screen shown in FIG. 17, the menu button 50 is added to the display screen shown in FIG. 12. When the user taps the menu button 50, the display screen is changed to a display screen shown in FIG. 18 displaying a menu of transmission services. With this display screen, the user can set detailed search conditions. When the user taps the return button 150 in the display screen shown in FIG. 18, the display screen is changed back to the display screen shown in FIG. 17.

The user can set a search condition for any item in the menu shown in FIG. 18. The items for setting are substantially the same as those shown in FIG. 16. In the example shown in FIG. 18, unlike in the example in FIG. 16, the range of search targets includes films in addition to broadcast programs. This meets the desire of the user for viewing a film relevant to the part of the document selected by the user. In the example shown in FIG. 18, it is assumed that the recorded programs are provided from a business entity. Therefore, notes regarding the charge are displayed as “Notes”.

Owing to the above-described structure, the example shown in FIG. 17 and FIG. 18 also allows the user to set detailed conditions for a moving image that he/she wishes to view. After the user taps the transmission button 100, the third server 40 may select a moving image matching the conditions in accordance with the desire of the user, so that the information processing terminal 10 reproduces the moving image promptly. Alternatively, before the reproduction is started, the title, the reproduction time length, the outline and the like of the moving image to be reproduced may be sent, so that the user makes a final confirmation. In the case where there are a plurality of candidates for the moving image to be reproduced, the user selects one of the candidates and taps the reproduction button 200. After this, the moving image is reproduced. According to such a structure, especially when the user selects a film and thus the reproduction time length is long, the user can be reminded that the charge for viewing is high.

In this embodiment also, the first server 20, the second server 30 and the third server 40 may be implemented by different devices respectively, or random two, or all of, these devices may be implemented by one device. The first server 20, the second server 30 and the third server 40 may be managed by different business entities, or random two of, or all of, these devices may be managed by one business entity.

### Embodiment 4

Now, Embodiment 4 will be described. In the above embodiments, the electronic document display system searches for, and reproduces, a recorded program relevant to an electronic document. This embodiment is regarding a system and an information processing device capable of acquiring various types of information such as a map, webpage, moving image and the like as well as a recorded program, and displaying such information together with the electronic document. Hereinafter, differences from the above embodiments will be mainly described.

[4-1. Structure]

FIG. 19 shows a structure of the entirety of an electronic document display system in this embodiment. In this embodiment, the electronic document display system includes the first server 20 for distributing an electronic document, a sixth server 70 for holding various types of data such as a document, a still image, a moving image and the like, and the information processing device 10. The first server 20 and the information processing device 10 are the same as those in any one of the above embodiments and will not be described in detail. The sixth server 70 holds data such as a moving image, a still image and a document associated to keyword information in a storage section 71 thereof. FIG. 19 shows that, as an example, the storage section 71 stores an HTML document, a map image, a moving image and the like.

[4-2. Operation]

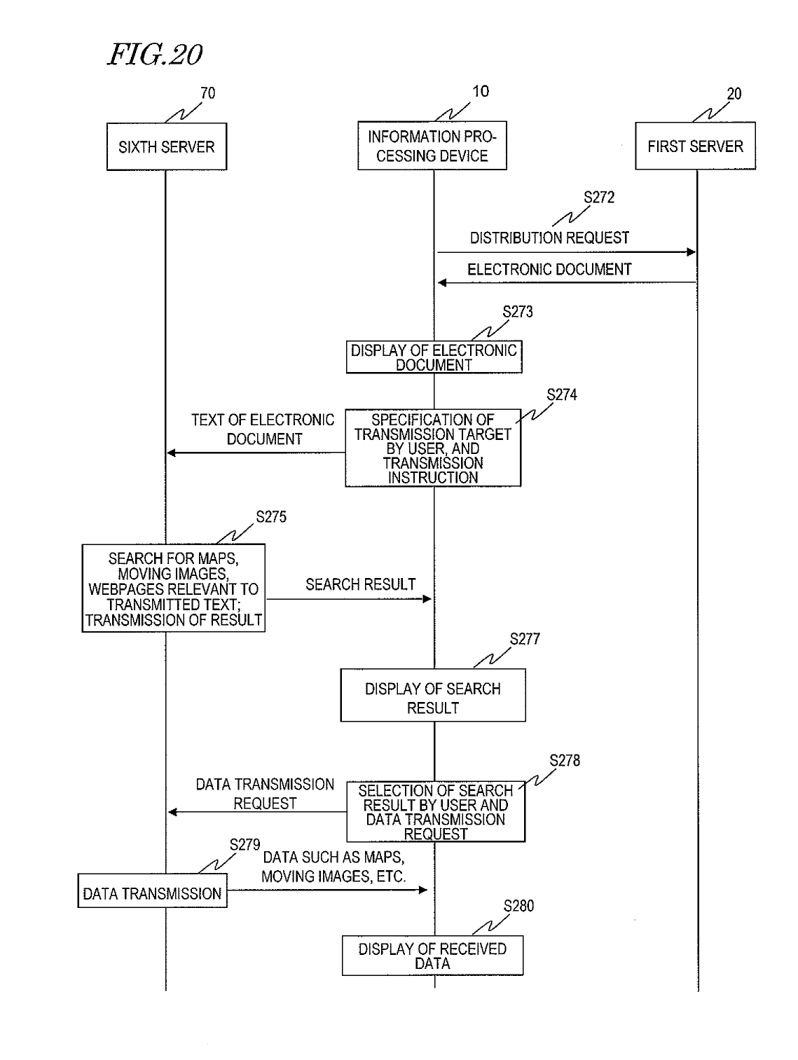

FIG. 20 shows an operation of the electronic document display system in this embodiment. In step S272, the information processing device 10 receives data on an electronic document. Then, in step S273, the information processing device 10 has the electronic document displayed on a display screen built therein, or connected thereto. An image of the electronic document displayed in this step is substantially the same as that shown in, for example, FIG. 5 or FIG. 12. Next, in step S274, when detecting that the user of the information processing device 10 has got interested in a part of the electronic document and tapped the transmission button 100 in order to acquire information relevant to the part, the information processing device 10 issues a transmission instruction to the sixth server 70. In this step, text information relevant to the part selected by the user is sent to the sixth server 70. Upon receipt of the text information, in step S275, the sixth server 70 extracts information such as a map, moving image, webpage or the like associated to keyword information matching to, or similar to, the keyword of the text information, and transmits the result to the information processing device 10. Upon receipt of the search result, in step S277, the information processing device 10 has the result displayed on the display screen.

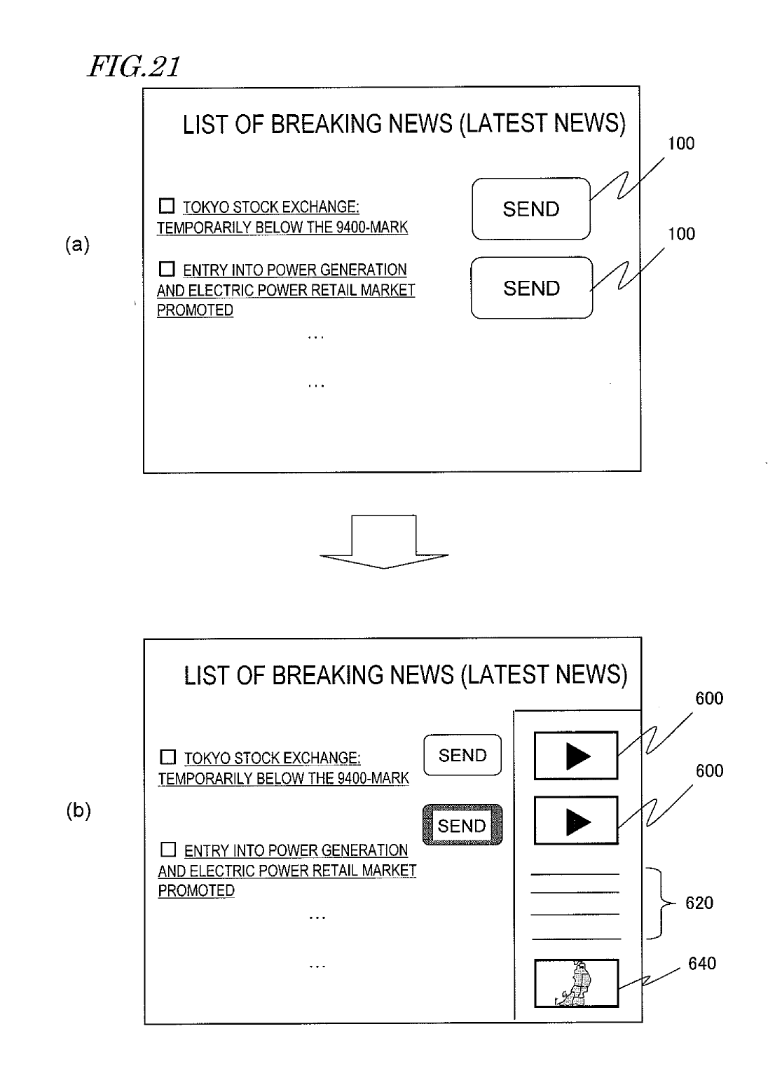

FIG. 21 shows an example of change of the display screen in step S277. FIG. 21(a) is the same as the display screen shown in FIG. 5. When the user taps the transmission button 100 corresponding to “Entry into power generation and electric power retail market promoted” in the display screen of FIG. 21(a), the sixth server 70 executes a search operation. Upon receipt of the search result, the information processing device 10 changes the display screen to the display screen shown in FIG. 21(b). In the example shown in FIG. 21(b), the display screen presents a link 600 to a moving image relevant to a keyword attached to the article “Entry into power generation and electric power retail market promoted”, a link 620 to a webpage relevant to the keyword, and a link 640 to a map image relevant to the keyword.

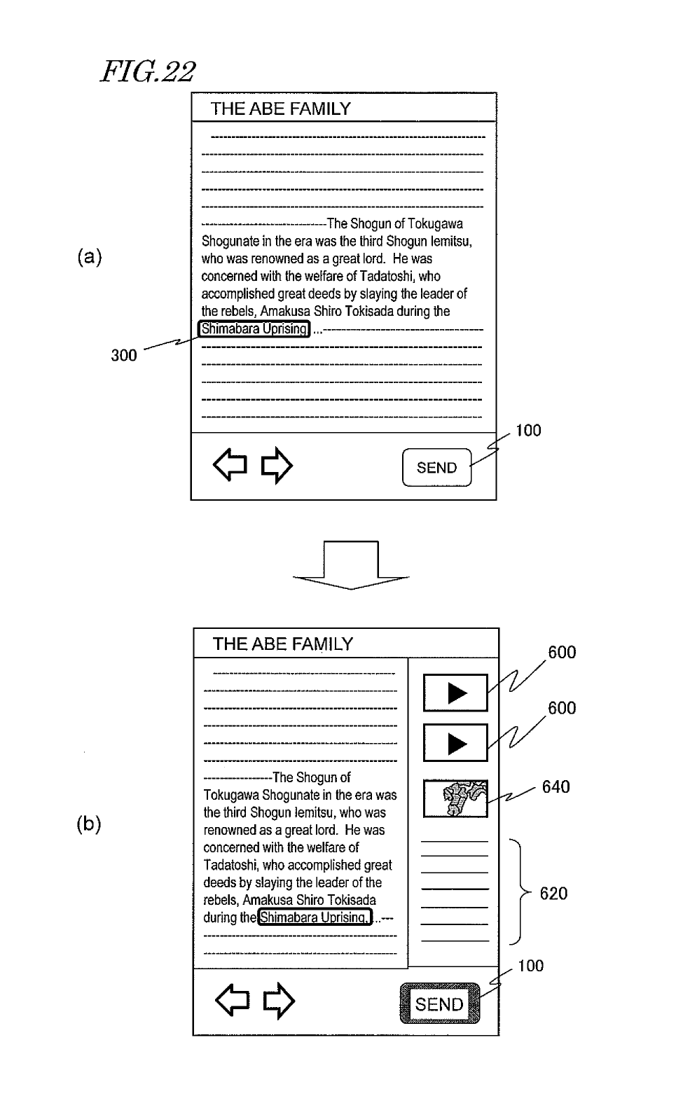

FIG. 22 shows another example of change of the display screen in step S277. FIG. 22(a) is the same as the display screen shown in FIG. 12. When the user taps the transmission button 100 in the display screen of FIG. 22(a) after selecting the language “Shimabara Uprising” in the electronic book by a drag operation or the like, the sixth server 70 executes a search operation. Upon receipt of the search result, the information processing device 10 changes the display screen to the display screen shown in FIG. 22(b). In the example shown in FIG. 22(b), the display screen presents the link 600 to a moving image relevant to the language “Shimabara Uprising”, the link 620 to a webpage relevant to the language, and the link 640 to a map image relevant to the language.

In step S278, when the user selects one of these links, the controller 16 of the information processing device requests the sixth server 70 to transmit data on the selected link destination. In steps S279, the sixth server 70 transmits the data on the requested moving image, webpage, or map image to the information processing device 10. Upon receipt of the data, in step S280, the information processing device 10 causes the display screen to display the moving image, webpage, or map image.

Instead of the link 600 to the moving image, the link 620 to the webpage or the link 640 to the map image, a moving image, a webpage or a map image itself may be displayed together with the electronic document. For example, in the case where the information considered to be most relevant to the contents selected by the user is a moving image, the moving image may be displayed instead of the link and reproduced. Alternatively, in the case where the sixth server 70 stores therein data of a dictionary or encyclopedia, the data may be acquired and a definition of the term selected by the user or the like may be displayed instead of the link. When such a structure is adopted, the steps S275, S277 and S278 shown in FIG. 20 may be omitted so that in step S275, only the most relevant information is transmitted from the sixth server 70 to the information processing device 10. The structure and display contents of the display screen showing the search result may be customized in accordance with the preferences of the user. For example, the display screen may be set to display an outline of the moving image or information representing the matching rate as shown in FIG. 14.

[4-3. Effects, etc.]

As described above, the system in this embodiment includes the first server 20 for holding an electronic document, the sixth server 70 for holding data on a moving image, still image, document and the like associated to the keyword information, and the information processing device 10. The information processing device 10 includes the network interface 11 for performing communication with the first server 20 and the sixth server 70, the input section 12 which is a user interface for accepting an operation made by the user, and the controller 16 for causing the display screen (display section) 13 to display the electronic document acquired from the first server 20. In response to a selection made by the user, the controller 16 transmits information relevant to the selected contents in the electronic document to the sixth server 70. Then, the controller 16 acquires, from the sixth server 70, data on a moving image, still image, document and the like associated to the keyword information matching to, or similar to, the transmitted information. Thus, the controller 16 causes the display screen to display such data together with the electronic document.

Owing to this, the user can acquire various types of information relevant to the part of the electronic document in which he/she is interested, at a time and in a timely manner. Especially in this embodiment, unlike in Embodiments 1 through 3, a wide range of information relevant to the article or language in which the user is interested while browsing the electronic document, as well as the recorded programs, can be collected at a time. Therefore, the user understands the article or the language more profoundly. As described above, in this embodiment, the information can be collected at a time. This allows the user to understand the topic in a multifaceted manner and organically. In the case where such information is collected over a plurality of times as by the conventional art, the user may not like taking time and thus may not collect the information. In such a case, the user loses an opportunity to learn. This embodiment avoids this, and the effect thereof is significant.

In this embodiment, the sixth server 70 is described as an independent device for holding a document, still image, moving image and the like. The sixth server 70 is not limited to such a form. For example, the sixth server 70 may be implemented by a group of a server of a business entity holding map data, a server of a business entity providing dictionary or encyclopedia services on the web, a server of a business entity providing webpage search services, and a server of a business entity providing moving images. Such servers may include a recorder owned by the user, such as the second server 30 in Embodiment 1. Alternatively, the sixth server 70 may act as a base of search for collecting relevant information from various servers described above via a network such as the Internet and providing the collected information together to the information processing device 10. According to such a structure, the user can acquire a wide range of relevant information from the servers all over the world and therefore can understand the contents of the electronic document that he/she is browsing more profoundly. As described above, the sixth server 70 may be an independent device or may include a plurality of devices. In this embodiment also, as in Embodiment 3 (FIG. 15 through FIG. 18), the electronic document display system may be structured such that the user can set conditions for search targets in detail. In this embodiment, electronic document display system may be structured such that, for example, conditions are set individually for web search, map search and moving image search.

In this embodiment, the sixth server 70 is assumed to make a web search, map search and moving image search at a time, as an example. The sixth server 70 is not limited to such a structure. The sixth server 70 may have any structure as long as holding at least one type of data among still image data, moving image data and document data associated to the keyword information and having a search function. In the case where the sixth server 70 holds at least two types of data among still image data, moving image data and document data associated to the keyword information, the information processing device 10 can acquire the at least two types of data and display such data together with the electronic document. This allows the user to understand the topic more profoundly. Needless to say, when all the three types of data are displayed together with the electronic document, or as the number of pieces of information displayed at the same time is larger, the display of such data or information is more advantageous to the user.

However, there are cases where it is not preferable to display a large number of pieces of information at the same time depending on the environment of use. Such cases are, for example, a case where the collected information is displayed on a small display screen, and a case where the total amount of received data is larger than the amount of data which can be processed by the controller 16. In such a case, the controller 16 may change the type or number of pieces of information to be displayed on the display screen together with the electronic document. For example, when the information is displayed on a low-resolution small display screen, only two pieces of information which are considered to be most highly relevant (having the highest matching rate) (e.g., one moving image and one definition of term), among from the collected information, may be displayed. By contrast, when the information is displayed on a high-resolution large display screen, three or more pieces of information (e.g., one moving image, one definition of term, and one map) may be displayed. In this manner, the controller 16 may adjust the type or number of pieces of information to be displayed at the same time in accordance with various factors such as the resolution of the display screen, the processing capability of the controller 16, the size of the received size or the like. A display screen for allowing the user to make such settings may be provided on the display screen.

### Other Embodiments

Embodiments 1 through 4 have been described for illustrating the technology disclosed in this application. The technology of the present disclosure is not limited to these embodiments, and is applicable to other embodiments in which various elements of the above-described embodiments are, for example, modified, replaced, added or deleted appropriately. Elements of the above-described embodiments may be combined to provide another embodiment. Hereinafter, such other embodiment will be described.

In the above-described embodiments, the information processing device 10 is mainly a media tablet. Alternatively, the information processing device 10 may be a PC, a smartphone or the like. In the case where the information processing device 10 is a desktop PC, the controller 16 has an electronic document or the like displayed on a display screen connected to the information processing device 10. The structure of the information processing device 10 shown in FIG. 1 or the like is merely exemplary. The information processing device 10 may have any structure as long as having the above-described function. The screen structure, the table structure, the flowchart and the like in the above description are exemplary and may be appropriately modified. For example, the transmission button 100, the reproduction button 200 and the like in each embodiment do not need to be displayed as buttons, and may be displayed in any other form which has substantially the same function. The electronic document display system may be structured such that the user does not need to press the transmission button 100, and when the user selects a part of the document, the information relevant to the selected contents is transmitted to the server. In Embodiments 1 through 3, the information processing device 10 may start reproducing a recorded program immediately after acquiring data thereof, or the user may be allowed to instruct the reproduction of a recorded program by use of gesture recognition, voice recognition or the like.

The technology of the present disclosure is applicable to software (program) which defines the processes in the above-described embodiments. An operation defined by such a program is, for example, as shown in FIGS. 3, 9, 11 and 20. Such a program may be provided as being stored on a portable storage medium or may be provided via an electric communication line. A processor built in the device executes such a program, and as a result, the operations described in the above embodiments can be realized.

So far, embodiment have been described for illustrating the technology of the present disclosure. The attached drawings and the above detailed description are provided for this purpose.

Therefore, the elements shown in the attached drawings or described in the above detailed description may include elements not indispensable to solve the problems as well as elements indispensable to solve the problems. Such elements not indispensable should not be recognized as being indispensable merely because they are shown in the attached drawings or described in the above detailed description.

The above-described embodiments are provided for illustrating the technology of the present disclosure, and may be, for example, modified, replaced, added or deleted in various manners within the scope of the claims and the equivalents thereof.

The technology of the present disclosure is usable for a device capable of receiving an electronic document and a system including such a device. The technology of the present disclosure is preferably usable for, for example, information processing devices such as work stations, personal computers, media tablets, smartphones and the like.

While the present disclosure has been described with respect to preferred embodiments thereof, it will be apparent to those skilled in the art that the disclosed technology may be modified in numerous ways and may assume many embodiments other than those specifically described above. Accordingly, it is intended by the appended claims to cover all modifications of the disclosure that fall within the true spirit and scope of the disclosure.

This application is based on Japanese Patent Applications No. 2012-098443 filed Apr. 24, 2012 and No. 2012-249025 filed Nov. 13, 2012, the entire contents of which are hereby incorporated by reference.

What is claimed is:

1. An information processing device, comprising:
a network interface configured to perform communication with a first server that stores an electronic document, a second server that stores a recorded program, and a third server that stores keyword information associated to the recorded program;
a user interface configured to accept an operation made by a user; and
a controller configured to cause a display screen to display the electronic document acquired from the first server, wherein the controller transmits, in response to a selection made by the user, information relevant to selected contents in the electronic document to the third server;
acquires, from the third server, information specifying at least one recorded program associated to keyword information matching to, or similar to, the transmitted information; and
reproduces the recorded program stored on the second server.

2. The information processing device of claim 1, wherein:
the keyword information is associated to each of scenes included in the recorded program; and
the controller acquires, from the third server, information specifying a scene associated to the keyword information matching to, or similar to, the information transmitted to the third server, and reproduces the scene of the recorded program stored on the second server.

3. The information processing device of claim 1, wherein the controller causes the display screen to display at least one item for setting a condition for a recorded program desired to be reproduced by the user.

4. The information processing device of claim 3, wherein the at least one item includes either one of genre, channel and reproduction time length of program.

5. The information processing device of claim 3, wherein the controller causes the display screen to display a menu button together with the electronic document, and when the user selects the menu button, causes the display screen to display a screen for setting a condition for the recorded program.

6. The information processing device of claim 1, wherein when acquiring information specifying the recorded program from the third server, the controller causes the display screen to display a reproduction button for reproducing the recorded program.

7. The information processing device of claim 1, wherein when acquiring information specifying the recorded program from the third server, the controller causes the display screen to display at least one of information representing an outline of the recorded program and information representing a degree of matching of the keyword information.

8. The information processing device of claim 1, wherein the controller transmits text information of a part, of the electronic document, selected by the user or tag information associated to the part to the third server as information relevant to the selected contents.

9. The information processing device of claim 1, wherein at least two of the first server, the second server and the third server are provided in one device.

10. An information processing device, comprising:
a network interface configured to perform communication with a first server that stores an electronic document and a second server that stores at least two types of data among moving image data, still image data and document data which are associated to keyword information;
a user interface configured to accept an operation made by a user; and
a controller configured to cause a display screen to display the electronic document acquired from the first server, wherein the controller transmits, in response to a selection made by the user, information relevant to selected contents in the electronic document to the second server; acquires, from the second server, at least two types of data among moving image data, still image data and document data which are associated to keyword information matching to, or similar to, the transmitted information; and causes the display screen to display at least two of the moving image, the still image and the document together with the electronic document.

11. A system, comprising:
a first server that stores an electronic document;
a second server that stores a recorded program;
a third server that stores keyword information associated to the recorded program; and
an information processing device;
wherein the information processing device includes:
a network interface configured to perform communication with the first server, the second server, and the third server;
a user interface configured to accept an operation made by a user; and
a controller configured to cause a display screen to display the electronic document acquired from the first server, wherein the controller transmits, in response to a selection made by the user, information relevant to selected contents in the electronic document to the third server; acquires, from the third server, information specifying at least one recorded program associated to keyword information matching to, or similar to, the transmitted information; and reproduces the recorded program stored on the second server.

12. A system, comprising:
a first server that stores an electronic document;
a second server that stores at least two types of data among moving image data, still image data, and document data which are associated to keyword information; and
an information processing device;
wherein the information processing device includes:
a network interface configured to perform communication with the first server and the second server;
a user interface configured to accept an operation made by a user; and
a controller configured to cause a display screen to display the electronic document acquired from the first server, wherein the controller transmits, in response to a selection made by the user, information relevant to selected contents in the electronic document to the second server; acquires, from the second server, at least two types of data among moving image data, still image data and document data which are associated to keyword information matching to, or similar to, the transmitted information; and causes the display screen to display at least two of the moving image, the still image and the document together with the electronic document.
